(19) United States
(12) Patent Application Publication
(10) Pub. No.: US 2009/0313886 A1
(43) Pub. Date: Dec. 24, 2009

(54) VARIOUS METHODS AND APPARATUS FOR SOLAR ASSISTED CHEMICAL AND ENERGY PROCESSES

(75) Inventors: Brian L. Hinman, Los Gatos, CA (US); John Henry Stevens, Palo Alto, CA (US)

Correspondence Address: Rutan & Tucker, LLP., 611 ANTON BLVD, SUITE 1400, COSTA MESA, CA, 92626, US

(73) Assignee: Sundrop Fuels, Inc., Pojoaque, NM (US)

(21) Appl. No.: 12/145,383

(22) Filed: Jun. 24, 2008

(51) Int. Cl. B01J 19/12; F01K 7/00

(52) U.S. Cl. 44/302; 422/186.3; 290/52

(57) ABSTRACT

A method, apparatus, and system are described in which products from a solar assisted Reverse Water Gas Shift (RWGS) reaction are used in a hydrocarbon fuel synthesis process to create a liquid hydrocarbon fuel. A water splitter splits water molecules into hydrogen and oxygen via the addition of the solar energy. A chemical reactor chamber mixes solar heated carbon dioxide gas with all or just a portion of the hydrogen molecules from the water splitter in a RWGS reaction to produce resultant carbon monoxide. A hydrocarbon liquid fuel synthesis reactor receives and uses either 1) all of the unconsumed portions of hydrogen from the RWGS or 2) the remaining portion of the hydrogen molecules from the water splitter and the resultant carbon monoxide molecules from the RWGS in the hydrocarbon fuel synthesis process to create a liquid hydrocarbon fuel.

### NOTICE OF COPYRIGHT

A portion of the disclosure of this patent document contains material that is subject to copyright protection. The copyright owner has no objection to the facsimile reproduction by anyone of the software engine and its modules, as it appears in the Patent and Trademark Office Patent file or records, but otherwise reserves all copyright rights whatsoever.

### FIELD OF THE INVENTION

Embodiments of the invention generally relate to use of solar receivers, such as heliostats, focusing the energy of the Sun on a unit containing a chemical reactor. More particularly, an aspect of an embodiment of the invention relates to use of solar receivers, such as heliostats, focusing the energy of the Sun on a unit containing a chemical reactor to heat gas up to temperatures, such as 1500 degrees Celsius or lower as an upper temperature limit, in order to form a hydrocarbon fuel, such as methanol, and possibly drive a Brayton turbine engine.

### BACKGROUND OF THE INVENTION

Carbon dioxide may be put to use in beneficial applications such as generation of a hydrocarbon liquid fuel, including methanol and gasoline.

### SUMMARY OF THE INVENTION

In general, various methods, apparatuses, and systems are described. Solar receivers may focus the energy of the Sun on a unit containing a chemical reactor to heat gas to provide energy needed for chemical transformations to occur. Water molecules may be split into hydrogen molecules and oxygen molecules via the addition of the solar power directed from one or more sets of solar receivers. A solar-energy-to-gas-heat-exchanger heats carbon dioxide gas via the addition of the solar power directed from the solar receivers. The hydrogen gas from the water splitter may also be heated by the solar power directed from the solar receivers. The heated carbon dioxide gas is mixed with a portion of the hydrogen gas from the water splitting process in a solar-assisted endothermic reverse water gas shift reaction to produce resultant carbon monoxide and water molecules. At some point, the carbon dioxide gas and hydrogen gas may be separated from the resultant carbon monoxide and water. The separated out carbon dioxide and at least a portion of the hydrogen gas may be recycled back to the solar-energy-to-gas-heat-exchanger area and/or mixing area.

### BRIEF DESCRIPTION OF THE DRAWINGS

The drawings refer to embodiments of the invention in which:

FIG. 01 illustrates an embodiment of a solar assisted process to create a liquid fuel.

FIGS. 1a, 1b, and 1c illustrate embodiments of a solar assisted process to create a hydrocarbon liquid fuel;

FIG. 2a illustrates a front view of an embodiment of the solar-energy-to-gas-heat-exchanger;

FIG. 2b illustrates an embodiment of a gas flow path thru the solar-energy-to-gas-heat-exchanger;

FIGS. 3a, 3b, and 3c illustrate embodiments of the gas flow through an embodiment of the reverse water gas shift portion of the unit to produce synthesis gas; and

FIGS. 4a and 4b illustrate a flow diagram to generate methanol from solar heated carbon dioxide.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of named components, connections, types of catalyst, etc., in order to provide a thorough understanding of the present invention. It will be apparent, however, to one of ordinary skill in the art that the present invention may be practiced without these specific details. In other instances, well known components or methods have not been described in detail but rather in a block diagram in order to avoid unnecessarily obscuring the present invention. Further specific numeric references such as first portion of gas, may be made. However, the specific numeric reference should not be interpreted as a literal sequential order but rather interpreted that the first portion of gas is different than a second portion of gas. Thus, the specific details set forth are merely exemplary. The specific details may be varied from and still be contemplated to be within the spirit and scope of the present invention.

In general, a method, apparatus, and system are described in which products from a solar assisted Reverse Water Gas Shift (RWGS) reaction are used in a hydrocarbon fuel synthesis process to create a liquid hydrocarbon fuel. Essentially, two main embodiments, as well as a couple of other embodiments, are described. The first solar assisted embodiment has all of the moles of hydrogen generated from the water splitter being heated up and run through the reverse water gas shift reaction. The heated hydrogen gas, carbon dioxide gas, and resultant carbon monoxide will then be cooled by exchanging their energy to preheat the feed gases. The second solar assisted embodiment merely heats up a portion of the moles of hydrogen generated from the water splitter and then sends the other portion of the non-superheated moles of hydrogen to the fuel synthesis process. Therefore, merely the heated carbon monoxide from the RWGS needs to be cooled enough to be sent to the fuel synthesis process while the non-superheated moles of hydrogen may already be close to the right temperature. In both of these embodiments, more moles of hydrogen are supplied to the RWGS reaction than is needed for equilibrium in order to overdrive the reaction to maximize the carbon monoxide production. In the first embodiment, the unconsumed hydrogen from the RWGS is routed in whole to the fuel synthesis process and during the routing is used in a recuperator to preheat new feed gases for the RWGS reaction. In the second embodiment, the unconsumed hydrogen from the RWGS along with any unconsumed carbon dioxide are also recycled back into the RWGS to preheat new feed gases for the RWGS reaction. However, the majority of the moles of hydrogen for the fuel synthesis process are being directly routed from the water splitter and thus are not superheated to take part in the RWGS. In both embodiments, a small percentage of the carbon dioxide may be sent along with the carbon monoxide and hydrogen to the fuel synthesis process. The small percentage, such as between 0.1% to 3% by volume of carbon dioxide, helps the fuel synthesis process.

Thus, an array of heliostats, or other solar concentrator, focus solar energy to a solar-energy-to-gas-heat-exchanger to heat the carbon dioxide gas and hydrogen gas. The same or another array of heliostats focus solar energy to a water splitter to split water molecules into hydrogen molecules (H2) and oxygen molecules (O2) via the addition of the solar energy. A chemical reactor chamber mixes the heated carbon dioxide gas with all or just a portion of the hydrogen molecules from the water splitter in a reverse water gas shift reaction to produce resultant carbon monoxide. A hydrocarbon liquid fuel synthesis reactor receives and uses either 1) all of the unconsumed portions of hydrogen from the RWGS or 2) the remaining portion of the hydrogen molecules from the water splitter and the resultant stabilized carbon monoxide molecules from the reverse water gas shift reaction in the hydrocarbon fuel synthesis process to create a liquid hydrocarbon fuel.

Thus, the water splitting process and the reverse water gas shift reaction process produce synthesis gas (a gas combination including carbon monoxide (CO) and hydrogen (H2)) via the addition of solar energy. The resultant synthesis gas from the RWGS reaction may be used to create any number of hydrocarbon liquid fuels, such as methanol and gasoline.

The Sun's energy may be concentrated, via one or more arrays of heliostats, a parabolic dish or trough, etc., to provide the energy needed for the chemical transformations to occur. The Sun's energy may be also coupled to a process for driving a Brayton turbine engine unit.

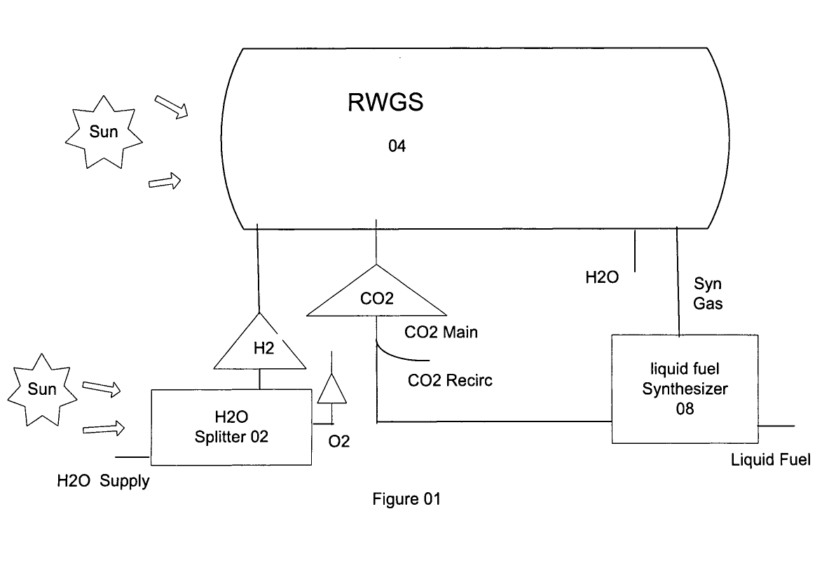

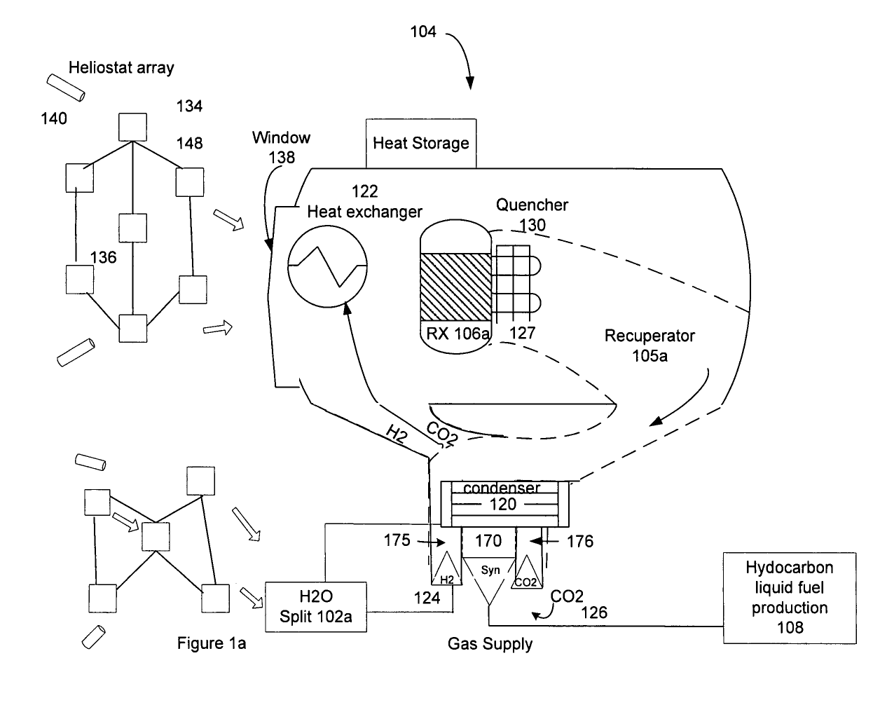

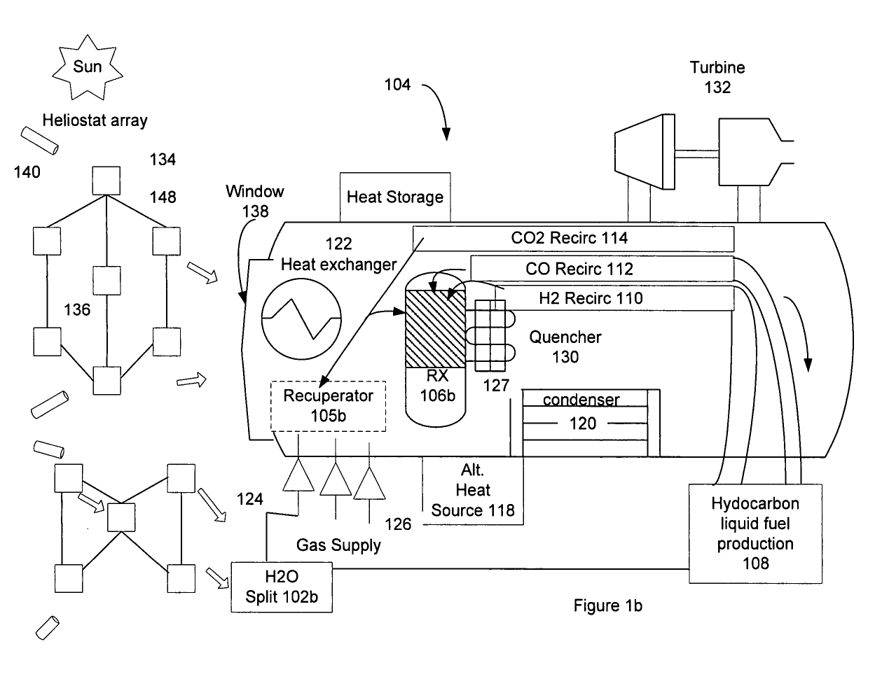

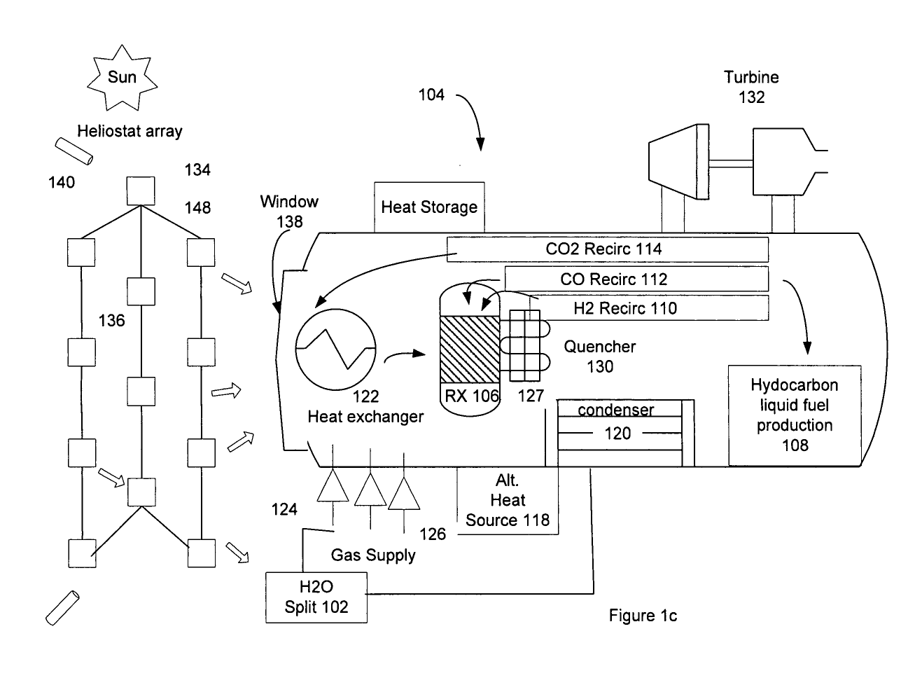

FIG. 01 illustrates solar assisted processes of water splitting and a RWGS reaction to supply a synthesis gas to a liquid fuel synthesis process to create a liquid fuel. Water is supplied to a water (H2O) splitter 02 that uses the energy of the sun to disassociate the H2O into H2 and O2 molecules. The produced H2 gas is supplied to the RWGS unit 04. The RWGS unit 04 also receives a supply of carbon dioxide. The RWGS unit 04 heats both the H2 and carbon dioxide with the energy of the sun and then uses the heated gases in a RWGS reaction to produce synthesis gas. The synthesis gas from the RWGS reaction may be used in a recuperator 05 to preheat the incoming feed gases of H2 and carbon dioxide. The synthesis gas is supplied to a liquid fuel synthesizer 08. The liquid fuel synthesizer 08 converts the synthesis gas to liquid fuel. The liquid fuel synthesizer 08 may also have carbon dioxide, and any imbalance of CO or H2 left from the synthesis process and all three of these gases can be recycled back to the carbon dioxide recirculation point back into the RWGS unit 04.

### Operation of the Reactor

FIG. 1a illustrates a solar assisted process to create a hydrocarbon liquid fuel. A water (H2O) splitter 102 can be used to supply H2 gas into a reverse water gas shift unit 104 that generates synthesis gas for production of a hydrocarbon liquid fuel, such as methanol. A reverse water gas shift reactor 106 and the hydrocarbon liquid fuel synthesis reactor 108 can be discrete units in which the water gas shift reactor 106 feeds the hydrocarbon liquid fuel synthesis reactor 108 to form methanol from Carbon Dioxide (CO2) hydrogenation (See FIGS. 1a and 1b). Alternatively, the reverse water gas shift reactor 106 and the hydrocarbon liquid fuel synthesis reactor 108 can be serially aligned in a single unit to form methanol from Carbon Dioxide (CO2) hydrogenation. (See FIG. 1c). Thus, the water splitting, reforming and synthesis units may be combined in a single unit or simply all located on the same site.

Referring to FIG. 1b, a H2 recirculation loop 110, a Carbon monoxide (CO) recirculation loop 112, and a carbon dioxide recirculation loop 114 may be part of the RWGS unit 104 and could be either discrete loops or combined. The RWGS unit 104 may also contain sections such as a water condenser/separator 120, a solar-energy-to-gas-heat-exchanger 122, the H2 gas supply line 124, which can be supplied by the H2O splitter or other H2 sources, the carbon dioxide gas supply line 126, and other gas supply lines 128, a quenching unit 130, a heat recuperator 105, and other similar components. The Sun's energy may also be stored within the RWGS unit 104 in a storage unit 116 for continued operations at night, or may be stored directly in a solar receiver. The RWGS unit 104 may also have an alternative supply of energy 118 for supplemental power or primary power in times of inadequate solar power or maintenance.

Referring to FIG. 1a, a solar assisted embodiment has substantially all of the moles of hydrogen generated from the water splitter 102a being heated up and run through the reverse water gas shift reaction in the chemical reaction chamber 106a.

Referring to FIG. 1b, another solar assisted embodiment merely heats up a portion of the moles of hydrogen generated from the water splitter 102b in the RWGS reaction and sends the remaining portion of the non superheated moles directly to the fuel synthesis process 108.

In both of these solar assisted embodiments, more moles of hydrogen are supplied to the RWGS reaction than needed for equilibrium in order to overdrive the reaction to maximize the carbon monoxide production.

The chemical operation may be summed:

1. Water (H2O) is split into H2 molecules and Oxygen (O2) molecules (2 H2O+energy--->H2+O2) via the addition of solar power in combination with standard H2 cleaving techniques, water splitting with a Titanium based alloy, or other similar techniques.

2. The carbon dioxide gas is heated by the heliostats 134 directing the rays of the Sun to the solar-energy-to-gas-heat-exchanger to a steady state temperature between 200-1000 Celsius as the gas exits the heat exchanger area 122. Complete conversion of carbon dioxide may occur around 900 Celsius without a catalyst. The hot carbon dioxide gas is mixed with the other gases for a reverse water gas shift reaction. However, in an embodiment, the carbon dioxide is heated by the Sun to the steady state temperature prior to being mixed with the hydrogen molecules for the reverse water gas shift reaction. A temperature, such as 1500 degrees Celsius (C.) or lower, may be established as an upper temperature limit for the reverse water gas shift reaction. Also, both the carbon dioxide gas and the feed H2 gas may be additionally pre-heated using the energy of the recycled gases and/or waste gases exiting the RWGS reactor 106 in a recuperator 105.

3. Next, the solar-assisted endothermic RWGS produces the resultant H2+CO molecules for the synthesis gas. In the reverse water gas shift, the heated carbon dioxide, from step 2 above, is added to the H2 molecules, from step 1 above, in a ratio such as 1 mole of carbon dioxide per 3 moles of H2 in potentially the presence of a catalyst plus the heat from the Sun to yield in the reactor at least CO+H2O+2H2. In another variant of the RWGS reaction, the formula may be represented as (2CO2+3H2+energy--->2CO+3H2O). The heated carbon dioxide and H2 mixture may be supplied to a Nickel alloy RWGS reactor 106, such as an Inconel 600™ reactor, Ni/Al2O3 reactor, etc. The flow rate of each gas, H2 and heated carbon dioxide, may be controlled to maximize the yield of CO produced based upon the supplied H2.

4. A portion of the exit gases from the RWGS reactor chamber 106, may then be immediately cooled/quenched by the quencher 130 to stabilize or otherwise capture at least the CO molecule.

The resultant CO plus 1) the unconsumed H2 molecules from the RWGS reaction or 2) the non-superheated H2 supplied directly from the water splitter 102 are used in the methanol synthesis step (5) below. Referring to FIG. 1b, ⅔rds of the hydrogen generated is supplied directly from the water splitter 102b to the fuel production unit 108 while the other portion of the H2, such as the remaining third, is mainly consumed in the RWGS reaction and any unconsumed hydrogen is recycled back into the RWGS synthesis gas production of step 3. Accordingly, the heated carbon dioxide gas and H2 gas would be separated from the resultant carbon monoxide and water.

In an embodiment, substantially all of the moles of hydrogen molecules 1) generated from the water splitter 102a and 2) passed through the chemical reactor chamber 106a, which are not consumed in the reverse water gas shift reaction are sent with the resultant carbon monoxide from the reverse water gas shift reaction and between 0.1% to 3% by volume of carbon dioxide in an inner pipe 170 to the hydrocarbon fuel synthesis 108 process to create the liquid hydrocarbon fuel.

5. Thru standard chemical processes, either on-site or off-site, hydrocarbon fuel synthesis occurs. A properly blended form of synthesis gas that includes (at least 2H2+CO) reacts with a catalyst to yield >CH3OH ΔrH (methanol)+heat, or another desired hydrocarbon fuel.

In an embodiment, the hydrogen splitting with TiO2 occurs at low temperatures and low sun units (50-80 degrees Celsius, 30-50 sun concentration, 15 psi pressure), reformation to synthesis gas occurs at a higher temperature (800-1000 degrees Celsius, 1000 sun concentration, 15 psi pressure), and the hydrocarbon fuel synthesis is an exothermic occurring at a moderate temperature (260 degrees Celsius, no sun, 1000 psi pressure).

In an embodiment, the carbon dioxide in step 2 may be heated high enough such as 900 Celsius to 2300 Celsius for solar assisted reduction of Carbon Dioxide to occur and the heated carbon dioxide is reduced to CO molecules and O2 molecules. The O2 from the carbon dioxide reduction and the H2O splitting may be cooled and stored as a liquid fuel or a portion may be used as a catalyst discussed later. This process will cause a lot of waste heat for use in other processes such as the synthesis gas generation and the heated carbon dioxide may also be used as an energy source to drive a Brayton turbine engine 132.

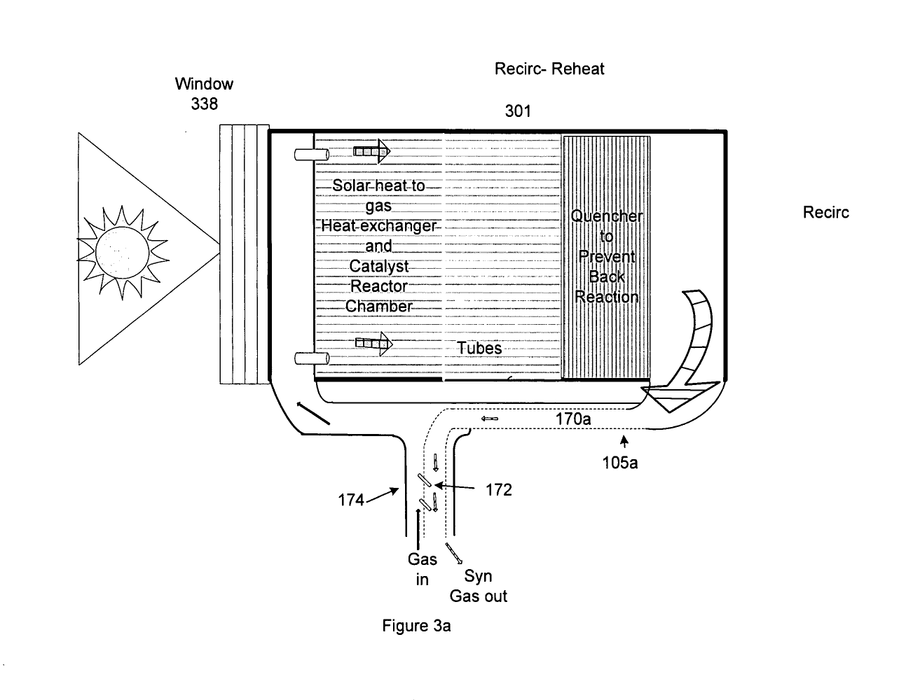

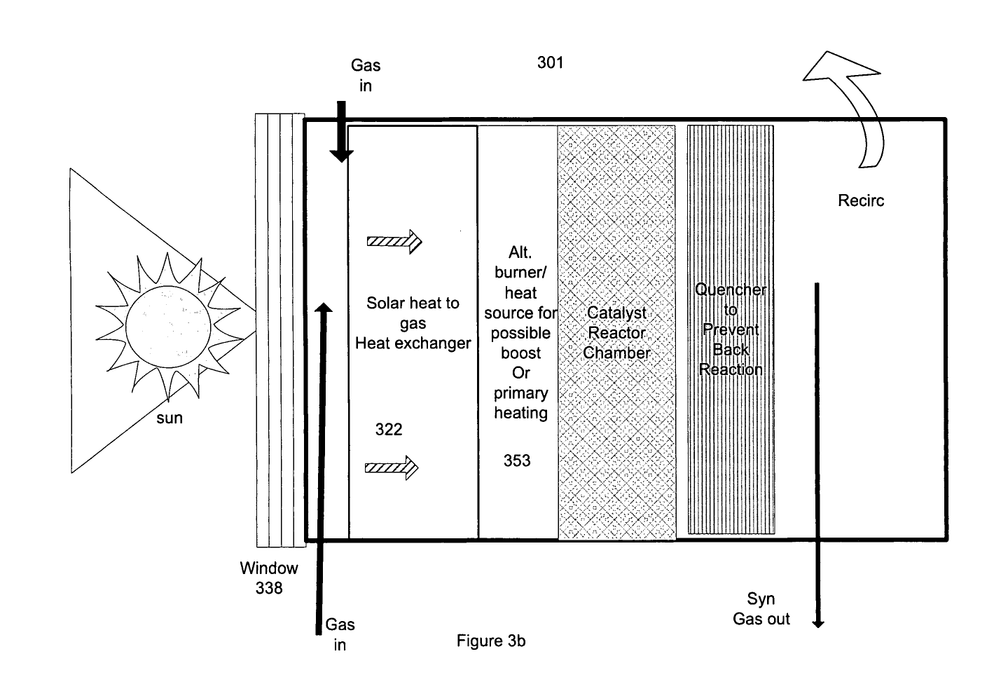

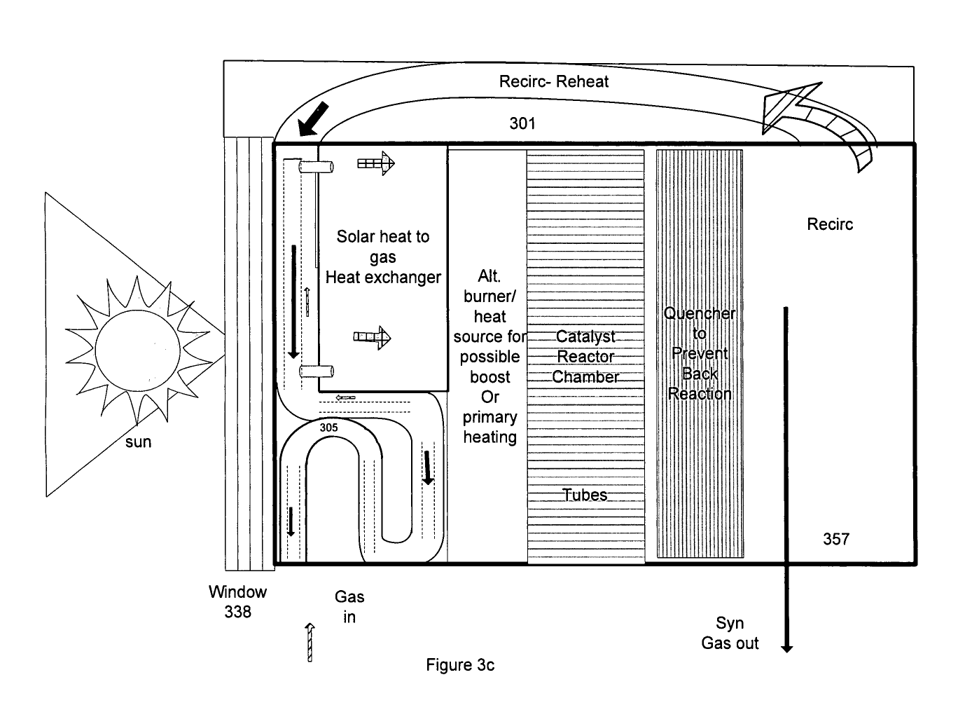

In an embodiment, the heat recirculation in step 2 happens in a recuperator 105 that allows heat to transfer from the outgoing gases to the incoming gases. The recuperator 105 uses the heat of the exhaust gases to pre-heat the feed gases, recovering as much of the heat/energy inputted initially from the Sun as possible. Mechanically, an example implementation of the recuperator, plumbs pipes to the gas input/output ports (See FIGS. 3a and 3b). In a simple form, the exhaust gases pass through an inner pipe 170 that is surrounded by a larger pipe carrying the feed gases in the annulus. The surface area necessary to transfer the heat is a function of the temperature change desired, the mass flow rates, the thermal conductivity of the gases, and the heat capacity of the gases.

Referring to FIG. 1a, as discussed in step 4, there can be three moles of hydrogen for every one mole of carbon dioxide when making methanol, and then one mole of hydrogen is compromised to make CO. However, all three moles of hydrogen may be mixed with or heated by waste carbon dioxide gas before doing the RWGS. The elevated temperature makes it easier to move the reaction toward completion.

The recuperator 105a plumbs pipes to the feed gases input ports 124, 126 and exhaust gases output ports from the quencher 130. The recuperator 105a passes the exhaust gases from the chemical reaction chamber 106a in an inner pipe 170 in order to pre-heat the feed carbon dioxide and hydrogen gases passed through a larger outer pipe carrying the feed carbon dioxide and hydrogen gases.

The recuperator 105a pre-heats both the feed carbon dioxide gas and hydrogen gas prior to the carbon dioxide gas and the hydrogen molecules entering the chemical reactor chamber 106a by transferring the energy of the exit gases (carbon dioxide gas, unconsumed hydrogen gas, resultant carbon monoxide, and resultant water) exiting the chemical reactor chamber 106a.

Referring to FIG. 3a, these exit gases flow in an inner pipe 170 with heat exchanging fins 172 interspersed into a outer pipe 174 containing the supplied feed H2 gas from the water splitter and the feed carbon dioxide gas. The feed carbon dioxide and H2 gases may be in the same outer pipe 174 as shown in FIG. 3a or each may have its own outer pipe 175, 176 and corresponding inner pipe containing exit gases. FIG. 1 a shows the hydrogen molecules from the water splitter 102a can be contained in a first outer pipe 175 and the feed carbon dioxide gas can be contained in a second outer pipe 176 during the heating by the unconsumed portions of the carbon dioxide gas and the hydrogen molecules from the reverse water gas shift reaction and the resultant carbon monoxide and water molecules in a first inner pipe 174.

Thus, the recuperator 105a cools the unconsumed portions of the carbon dioxide gas and the hydrogen molecules from the reverse water gas shift reaction and the resultant carbon monoxide and water molecules to preheat at least the hydrogen molecules from the water splitter and the feed carbon dioxide. Additionally, the recuperator 105a uses at least the unused hydrogen molecules from the reverse water gas shift reaction to preheat the feed hydrogen molecules and the feed carbon dioxide gas prior to the carbon dioxide gas and the hydrogen molecules entering the chemical reactor chamber 106a.

The cooled hydrogen molecules, the carbon monoxide, and a small percentage of the carbon dioxide from the reverse water gas shift reaction are sent to the hydrocarbon fuel synthesis process to create a liquid hydrocarbon fuel. Gas flow in the recuperator 105a is in the direction of the temperature gradient of the heat-exchanging surface. This minimizes entropy production in the process. Thus, the feed gas flow starts flowing along the inner pipe at its relative lowest temperature area and flows along the inner pipe 170 to the recuperator's 105a relative highest temperature area. Filters in the recuperator 105a remove a portion of the carbon dioxide once it has given up a majority of its heat to the feed gases. The condenser 120 couples to the recuperator 105a at its cooler end portion to remove the water gases from the produced synthesis gas. Also, the filtered out carbon dioxide is recycled back in with new feed carbon dioxide feed gas 126.

Thus, the reverse water gas shift reaction is driven to maximize production of carbon monoxide for a subsequent exothermic reaction in the generation of methanol as the hydrocarbon fuel, by, supplying at least fifty percent more moles of heated hydrogen molecules relative to an amount of carbon dioxide present in the chemical reactor chamber 106 than necessary to achieve equilibrium in the reverse water gas shift reaction to force maximum production of the resultant carbon monoxide.

Note, an implementation of the recuperator 105a as described, is an inner pipe for the exit synthesis gas and outer pipe for the feed gas. Other heat exchanging designs will also work. A main aspect should be two gas and/or liquid streams passing by each other going in opposite directions. A wall exists between the two streams that permits the heat to pass from the hot side to the cooler side, but the wall prevents the streams from physically mixing. For example, the synthesis gas may be one stream traveling in an outbound direction from the RWGS unit 104. The hydrogen input into the RWGS unit 104 from the water splitter 102a may be another stream receiving the heat from the synthesis gas and the carbon dioxide stream into the RWGS unit 104 may also be another stream receiving the heat from the synthesis gas.

Referring to FIG. 1b, as discussed in step 4, the chemical reactor chamber 106b mixes the heated carbon dioxide gas with a first portion of the hydrogen molecules from the water splitter 102b in the form of gas in the reverse water gas shift reaction in order to produce resultant carbon monoxide and water molecules. One or more filters 127 then separate out the heated carbon dioxide gas and hydrogen gas from the carbon monoxide and water produced in the reverse water gas shift reaction. One or more recycle pipes 110, 112, 114 recycle both the separated out carbon dioxide back to the solar-energy-to-gas-heat-exchanger area 122 and recycle at least a portion of the separated out hydrogen gas back to the into the hydrogen-carbon dioxide mixing area.

Thus, the reverse water gas shift reaction is driven to maximize production of carbon monoxide for the subsequent exothermic reaction in the generation of the hydrocarbon fuel, including methanol, by overloading an initial amount of hydrogen molecules relative to an amount of carbon dioxide present in the chemical reactor chamber during the reverse water gas shift reaction. The excess hydrogen from the initial batch (and subsequent batches) is both continuously recycled to preheat incoming feed gases as well ensure that RWGS reaction is overdriven with hydrogen molecules. However, in this embodiment, the remainder of the hydrogen produced from the water splitter 102b is sent directly to the fuel production 108 eliminating a need to cool the hydrogen gas for the fuel synthesis process.

As discussed in step 1, water may be split in H2 molecules and O2 molecules in the water splitter 124 via the addition of solar power in combination with standard H2 cleaving techniques, water splitting with titanium, or other similar techniques. Thus, 2H2O=2H2+O2=+57 kcal/mole. The resulting H2 is used as a H2 gas supply 124 to the single unit 104 at potentially a high temperature from the water splitter process. The produced H2 is then mixed with the heated carbon dioxide in the reverse water gas shift reaction reactor 106 and a portion is used in the hydrocarbon fuel synthesis reactor 108.

In an embodiment, the water splitter 124 via the addition of solar power from the heliostats 134 may use photo catalytic splitting of water into hydrogen and oxygen. Titanium oxide nanotubes coated with tungsten oxide can be prepared to harvest H2 and O2 with solar light. The tungsten trioxide coatings on the nanotubes can significantly enhance the visible spectrum absorption of the titanium dioxide nanotube array, as well as their solar-spectrum induced photocurrents. The catalytic Titanium dioxide materials use sunlight to split water on the spot, via a process known as direct solar-hydrogen production. The solar-hydrogen systems, when photons strike the catalytic material, they excite electrons, which then roam about freely until they meet a water molecule at the material's surface. The extra electrons strip the two hydrogen atoms away from water's one oxygen atom, producing hydrogen fuel. The oxygen atom simultaneously hooks up with another oxygen atom, forming an oxygen molecule.

A titanium disilicide catalyst can also be used with focused sunlight to split water into Hydrogen and Oxygen. The heliostats supply the energy to drive the H2O to H2 and O2. Titania is used to capture energy from sunlight. The absorbed energy releases electrons, which split water to make hydrogen. The Titania material may be strained so that its atoms are slightly pressed together or pulled apart to alter the material's electronic properties. A coating of Titania may be deposited on dome-like nanostructures that cause the atoms to be slightly pulled apart. By pulling the atoms apart, less energy is required to knock the electrons out of orbit. Thus, light with lower energy can be used to split H2O, which means both visible light and ultraviolet light can be used.

Note, the strain on the atoms also affects the way that electrons move through the material. Too much strain and the electrons tend to be reabsorbed by the material before they split water. Thus, a balance between absorbing more sunlight and allowing the electrons to move freely out of the material is attempted to be achieved with the strain applied. The TiO2 can be stressed to lengthen the band gap by mechanical and/or chemical means.

Also, a UV reflector made from a reflective metal material, such as aluminum, can reflect the UV spectrum, and then focus that energy on the water splitter 102. The water splitter may be a tower mounted device that contains clear tubes, such as quartz or borosilicate, that are filled with H2O in the form of gas or liquid reacting with the titanium.

After the carbon dioxide is converted to CO and H2O by the reverse water gas shift reaction in the RWGS reactor, the exiting water (H2O) from that chemical transformation is removed by the condenser 120 before the methanol is synthesized. With the elimination of water by RWGS, the purge gas volume is minimized as the recycle gas volume decreased. Because of the minimum purge gas loss by the pretreatment of RWGS reactor 106, the overall methanol yield may be increased. Also, the removal of water vapor from the reactor 106 via the condenser 120 can drive the equilibrium of the RWGS reaction to the right to increase the yield of CO produced per inputted heated carbon dioxide. The condensed water from the condenser 120 can be recycled to the H2O water splitter 102. The condenser 120 for water removal could either be a desiccant bed or cooling condensing apparatus.

As discussed in the RWGS step 3, in an embodiment, at 900 degrees Celsius, even with all the moles of hydrogen going into the RWGS receiver, the RWGS reaction may get about a 75% conversion from carbon dioxide into CO. As the liquid fuel synthesis process is actually benefited by a bit of carbon dioxide being present in the synthesis gas, and some liquid fuel processes more than others, the carbon dioxide will remain in the synthesis gas stream all the way through to the input of the liquid fuel production unit 108. The excess carbon dioxide is then separated out easy at that point. Aside from the liquid fuel being produced by the liquid fuel production unit 108, the liquid fuel production unit 108 can recycle additional chemical products back into the water splitting unit 102 and RWGS unit 104 such as liquid water, carbon dioxide, and any imbalance of CO or H2 left over. The liquid fuel production unit 108 may utilize these chemicals in other ways as well.

### Operation of the Heliostat Array

A field of sun-tracking mirrors (heliostats) 134 reflects sunlight onto the solar-energy-to-gas-heat-exchanger 122 in the RWGS unit 104 and potentially in the water splitter unit 102. A window 138 exists in the RWGS unit 104, where the heliostats 134 focus the solar energy thru the window 138 to the solar-energy-to-gas-heat-exchanger 122. A receiver exists in the water splitter unit 102 to allow the solar energy directed from the heliostats to be used in the water splitting process.

The heliostats 134 each may include a mirror of less than two meter squared. The small mirrors, such as a first mirror 136, can use a technique that allows the mirrors to be calibrated in groups. The smaller mirrors also require less support structure since the wind loads are much lower. Also, by spacing the mirrors in a regular pattern, the support structure 148 carrying the heliostats can be a standardized frame easily installed in the field. The frame 148 can be balanced with a number of adjustable legs. The mirrored arrays use this carriage linkage frame 148 to tie them together and communally use a shared camera tracking system 140 for calibration.

The heliostats 134 are constructed and periodically calibrated to be able to hit the receiver in the water splitter 102 and the window 138 in the RWGS unit accurately and with repeatability. A factor in the repeatability is related to the structural stiffness of the heliostat armature, as well as the backlash or slop within the drive mechanisms.

The RWGS unit 104 generally requires enough heat input from the concentration of the Sun's energy by the heliostats 134 to at least allow the chemical reactions to proceed. The heat input from the Sun provides enough energy for: 1) heat required to raise the temperature of the fresh feed gas to reactor temperature, 2) heat required to raise the recycled gas to the reactor temperature, 3) heat required to maintain reactor temperature while the endothermic reaction(s) occur, 4) heat loss/leak to the surroundings, 5) potentially enough heat to drive the Brayton engine 132 and 6) thermally reduce carbon dioxide in O2 and CO.

Accurate calibration of each heliostat can be done by taking data points with a device such as a set of cameras connected to digital imaging software in a computer, which can then be used to back-calculate heliostat position in the field relative to the target (i.e. RWGS reactor unit/water splitter), the base pose of each heliostat, as well as inconsistencies between the heliostat mechanism design and the actual manufactured assembly. For example, the camera-based methodology for heliostat calibration can have a couple 4 or more video cameras 140 installed at the periphery of the field, and pointed towards all of heliostats in the array 134 with a wide-angle view of the field. During a calibration phase, the system collects pointing events from individual heliostats into individual cameras. The current position of heliostats is compared to estimates for expected position and parameters for each heliostat. To account for shifts in land geometry, temporal sag, etc, the system is goes through and systematically calibrates its estimates for a small percentage of its heliostats at a time on a regular periodic basis.

As discussed, the small size of the heliostats means a very low wind profile, which translates into higher reliability in all wind conditions, lower risk of wind damage, and more power plant up-time. The heliostats themselves are small in area less than two meters square and close in proximity to the ground. The wind boundary layer close to the grounds makes the wind velocity lower than at higher elevations above the ground. The linear packing of heliostats in a row attenuates the wind load effect on heliostat within the group of heliostats not on the edge of the group relative to exposure to the direction of the wind drafts. Thus, inner heliostats may be engineered for lower loads.

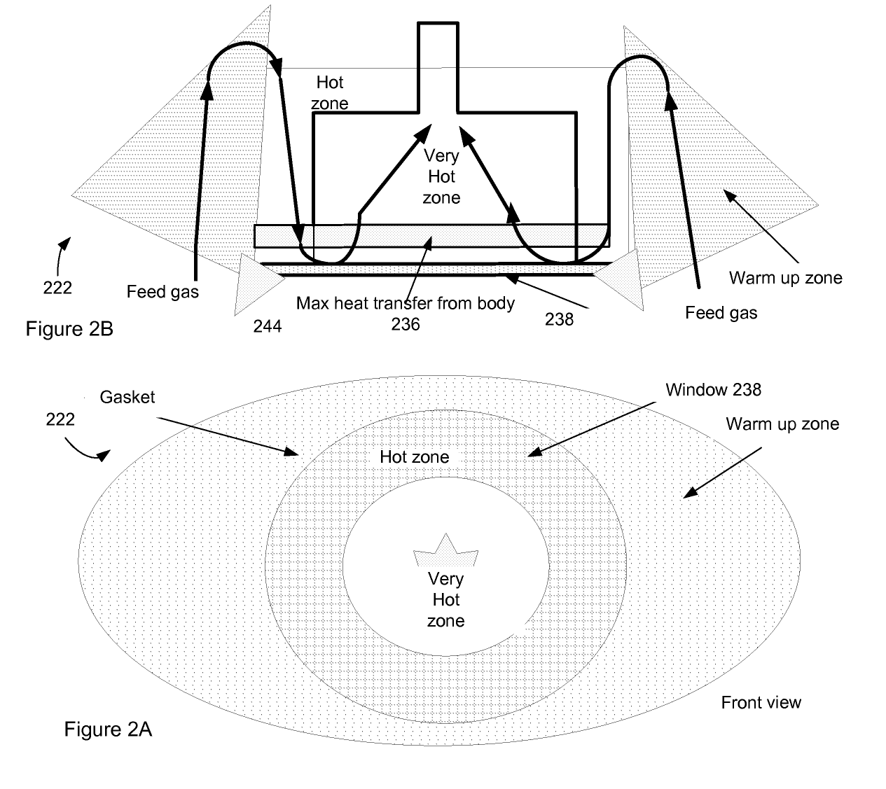

FIGS. 2a and 2b illustrate an embodiment of a solar-energy-to-gas-heat-exchanger. FIG. 2a illustrates a front view of the solar-energy-to-gas-heat-exchanger. FIG. 2b illustrates a gas flow path thru the solar-energy-to-gas-heat-exchanger. Referring to FIGS. 2a, and 2b, in an embodiment, the concentrated heat from the Sun can be focused by the array of heliostats on a contained supply of carbon dioxide gas through a window 238. The solar energy is focused on a fixed object, the main body portion of the solar-energy-to-gas-heat-exchanger 236, that the gas passes over. The heat is transferred to the gas through convection heating from the hot solar-energy-to-gas-heat-exchanger 222 to the flowing by gas. The shape and flow patterns of the solar-energy-to-gas-heat-exchanger 222 allows the wrinkled foil hot body heat exchanger to operate at lower temperatures and higher volumes to get the flow rate of heated carbon dioxide to commercially acceptable levels. In addition, a wrinkled foil hot body heat exchanger lends itself to a catalytic reverse water gas shift reaction. Specifically, a nickel coated copper foil could work very well for that.

Gas flow in the heat exchanger 222 is in the direction of the temperature gradient of the heat-exchanging surface. This minimizes entropy production in the process. Thus, the gas flow starts flowing along the solar-energy-to-gas-heat-exchanger 222 at its relative lowest temperature area and flows along the heat exchange to the heat exchanger's 222 highest temperature area.

The basic mass of the heat exchanger can include gear wrinkling of copper foil that is scrolled with smooth copper foil to form a heavy, fine-passage body. Multiple passes of the gas through the foil coil can be used achieve the desired high temperature. It is typically the case that the outside edges of the heat exchanger are cooler than the inside both because the center of the solar spot is more intense than the edges, so early passes would be on the outside with final passes on the hot center. Thus, the shape of the reactor and materials used to create the heat exchanger 222, such as a crinkled coil of copper, improve the volume of gas that may be heated by the solar-energy-to-gas-heat-exchanger 222. Similarly, the process may use a counter flow technique along the crinkled copper bar and, thus, flow from the coolest portion to hottest portion all to increase the volume of carbon dioxide gas heated up to produce commercial quantities of synthesis gas from the reverse water gas shift reaction.

The solar-energy-to-gas-heat-exchanger 222 uses convection heating from a fixed object, itself, to heat the passing by stream of carbon dioxide gas. This allows a lot of the energy for the chemical transformation and potential subsequent driving of the Brayton engine to be easily stored in the location where that energy is needed. In contrast, if merely the flowing gas was heated in some other method, then soon as that flowing gas exited the initial heat exchange area a subsequent quantity of feed gas would have to be heated up from scratch. The fixed solar-energy-to-gas-heat-exchanger 222 creates a stabile area to generate large volumes of gas in an effectively small area. The heat can be used to heat gas and the heated gas is used in the production of more synthesis gas and/or be driven into a Brayton engine

In an embodiment, the solar-energy-to-gas-heat-exchanger 222 may have a radially variable flow channel cross section through the crinkled foil. The solar-energy-to-gas-heat-exchanger 222 uses deeper crinkles near the center of the coil. This helps to even out the strong heating near the center of the apparatus. Small channels at the outside of the coil help to catch up the outside heating. This is important for the case where the light that passed through the large central channels is needed to help drive the RWGS reaction down stream.

Secondary concentrators 244 at the mouth of the device by the window collect and direct errant beams to the outside of the main body portion of the solar-energy-to-gas-heat-exchanger 236 where the heat is most needed.

A small net aperture can help minimize can help heat loss through the mouth. Also double quartz windows 222 can be used to deflect the resultant hot wind away from the cold and gas tight exterior window. The aperture may also be bigger and an absorptive material rather than clear material.

FIG. 3a illustrates an embodiment of the gas flow through an embodiment of the RWGS portion of the unit to produce synthesis gas. FIG. 3b also illustrates an embodiment of the gas flow through an embodiment of the RWGS portion of the unit to produce synthesis gas. The carbon dioxide and H2 gases are heated as discussed above. An alternative source of heating may also be employed as discussed later. The flow rate and residence time in the RWGS production line 301 may be controlled by the pressure on the gas controlled by the supply valves and or internal pumps, the diameter of the piping within the RWGS unit, the length of contact and mixing area within the RWGS reactor, and combinations of all three of these features.

Referring to FIG. 3a, the solar heater to gas heat exchanger and catalyst reaction chamber are combined into tubes lined with catalyst material. The combined solar receiver can be made of tubes (either metal or quartz), coated or filled with an appropriate catalytic material in a structural arrangement that maximizes the contact area while lowering the activation energy for the reaction. A catalyst material such as Ni/Al2O3 may be used. In addition, the RWGS reaction can take place rapidly in the presence of an iron-chrome catalyst at around 400 degrees Celsius. The recuperator 105a cools the unconsumed portions of the carbon dioxide gas and the hydrogen molecules from the reverse water gas shift reaction and the resultant carbon monoxide and water molecules and uses the energy of these gases contained in the inner pipe 170 to preheat at least the hydrogen molecules from the water splitter and the feed carbon dioxide.

Thus, the recuperator 105a plumbs pipes to the feed gas input ports and passes the exhaust gases from the chemical reaction chamber in an inner pipe 170 to pre-heat the carbon dioxide and hydrogen gases passed through a larger outer pipe carrying the carbon dioxide and hydrogen gases. The recuperator pre-heats both the carbon dioxide gas and hydrogen gas using energy of at least the recycled carbon dioxide gas exiting the RWGS reactor prior to carbon dioxide gas and the hydrogen gas entering the chemical reactor chamber.

In an embodiment, oxygen is also allowed to be present in the reverse water gas shift reaction to act as a catalyst. For example, an active and stable catalyst with a metal oxide composition such as Cu/ZnO/ZrO2/Ga2O3 (5:3:1:1) may be used or simply a small presence of O2 gas. The catalysis is a way of accelerating the rate of a chemical reaction by means of contacting the reactants with a substance called a catalyst, which itself is not substantially consumed by the overall reaction.

In another embodiment, an oxygen gas trap is present right before the mixing chamber and subsequent reaction zone in the reactor to remove potential present oxygen molecules from the reaction.

Also, the RWGS reaction can occur in vessels where the reacting gases will be exposed to the metal surfaces within the reactor. The metal wall surfaces of the RWGS reactor can have catalytic effects on the rate of reaction. Near-equilibrium conversions are anticipated at temperatures greater than 873 Kelvin in the RWGS reactor. The RWGS reactor may be made of Ni based alloy such as Inconel 600 (72% Ni, 17% Cr, and 10% Fe). Inconel 600 surface area in the RWGS reactor may be increased by adding a plurality of rings made of Inconel 600 packing.

Chemical conversion rates attained in a high-Ni alloy reactor operating at comparable conditions are anticipated to be greater than those realized in other types of reactors. However, the Inconel® 600 surfaces, can be depleted of nickel during the catalyzing reaction.

Corrosion of a metal reactor can occur due to the formation of carbon deposits in H2-CO—H2O environments in the temperature range 400-800 Celsius. The carbon diffuses into the metal and the Nickel migrates to the surface forming small pure-metal particles. However, corrosion may be minimized by adding an inert gas in presence of plasma to carry the carbon deposits away.

As discussed, the RWGS reaction, CO2+H2-->CO+H2O=+9 kcal/mole is mildly endothermic and will occur rapidly in the presence of a catalyst at temperatures of 400 degrees Celsius or greater and even without a catalyst at higher temperatures. Practical ways to drive the RWGS reaction to completion can include:

a) The Carbon Dioxide recirculation loop from the system increases reactor yields. Overload the reactor with heated carbon dioxide to force the complete consumption of the H2, and then recycle the excess carbon dioxide in the exhaust stream back into the reactor.

b) The Hydrogen recirculation loop from the system increases reactor yields. Overload the reactor with H2 to force the complete consumption of the carbon dioxide, and then recycle the excess H2 in the exhaust stream back into the reactor.

c) Operate the system that removes water vapor from the reactor via the condenser, thereby driving the equilibrium of the RWGS reaction to the right. Such a water removal system could either be a desiccant bed or cooling condensing apparatus.

d) Combine approaches (a) and (c).

e) Combine approaches (b) and (c).

Thus, in an embodiment, the reverse water gas shift reaction is also driven to maximize production of carbon monoxide for the subsequent generation of methanol, by removal of water vapor from the chemical reactor chamber via the condenser, supplying at least ten percent more moles of heated carbon dioxide to the chemical reactor chamber then necessary to achieve equilibrium in the reverse water gas shift reaction to force maximum consumption of the supplied hydrogen, and then recycling excess carbon dioxide gas in the exit gases back to the solar-energy-to-gas-heat-exchanger. The supplied carbon dioxide may be up to 60% more moles of heated carbon dioxide than necessary.

Other catalyst candidates for the RWGS reactor include catalysts that are the most productive in creation of carbon monoxide from the heated carbon dioxide. Three example groups of catalysts appear to be suitable for this application:

1. Copper (Cu) supported catalysts

2. Gold (Au) supported catalysts

3. Molybdenum (Mo) compounds

The quencher stabilizes the newly formed CO and H2 molecules.

The produced synthesis gas may include hydrogen, carbon monoxide and carbon dioxide. Some small amount of carbon dioxide mixed with CO and H2 is in fact desirable to assist the synthesis process for methanol. A gas supply output supplies at least the resultant stabilized carbon monoxide molecules from the reverse water gas shift reaction, hydrogen gas, and potentially some carbon dioxide to a hydrocarbon liquid fuel synthesis reactor. Thus, the reverse water gas shift reaction occurs to create at least one part of the synthesis gas that is then used to create any number of hydrocarbon liquid fuels such as methanol, ethanol, diesel fuel, crude oil, and gasoline. Catalytic processes exist to synthesize any of these fuels directly from the supplied base synthesis gas that at least includes hydrogen and carbon monoxide.

Note, another possible side reaction, formation of methane (CH4), can occur in an Inconel or any other suitable high temperature alloy or material reactor. The concentration of methane at the outlet of the reactor will exhibit temperature dependence reaching a maximum value at 1023 Kelvin. Methane formation in a CO—CO2-H2-H2O system is possible via the below reactions.

CO+3H2--->CH₄₍ₘₑₜₕₐₙₑ₎+H2O (1)

2CO+H2--->CH4+CO2

The methane and water produced by the above reaction (1) are easily separated in the condenser. The methane may be reformed into synthesis gas or liquefied and stored, while the water is condensed and removed.

Accordingly, the methane may be reformed with the Sun's energy to produce synthesis gas. Methane reformation occurs: CH4 (methane)+30% heated carbon dioxide from the Sun+H2O--->CO+3H2 ΔrH=+206 kJ mol-1. Some of the heated carbon dioxide from the heat exchanger can be routed for the methane reformation.

A portion of the hydrogen from the methane reformation can recycled back into the RWGS reactor to produce more synthesis gas, methane, and water, and so forth, while the other portion is used for hydrocarbon fuel generation. It will be noted that the above reactions reaction may only produce a portion of the hydrogen molecules to recycle back to the RWGS reaction. Thus, a net input of hydrogen may be required to make the system run.

Note, the fuel and oxygen produced during the day or on previous days is stored in the solar energy storage unit and can be burned in the single unit at night with no greenhouse gas emissions.

As discussed, the input stream of carbon dioxide can be converted into synthesis gas and later methanol. The carbon dioxide can be obtained, for example, from a fossil burning power plant that has a continuous output of carbon dioxide that pollutes the atmosphere. The unit can take those harmful emissions and convert them into methanol. Methanol burns cleaner than gasoline, but is similar in its portability and versatility, and can be used in many of today's existing engines.

Referring to FIG. 3b, the deployment of a burner 353 in conjunction with the solar heater 322 allows a continuous hot gas stream during clouds or even over night. This can be important to allow continuous operation of sophisticated, inflexible plant machinery down stream. The burner 353 will be located down stream and down line of the inputted Sun from the primary heating foil coil. The burner flames can be only at the periphery of the heater. The fuel lines to the interior may be shaded from the sun's beams by steel structures just over the fuel tubes. The inside of the lines are also cooled by rapidly flowing fuel. Solar generated fuel (hydrogen or other) and solar derived oxygen can be used to feed this burner. This keeps the fraction of energy in the final product highly solar in origin.

Quenching (rapid cooling) of the process gas is important for carbon dioxide splitting as well as carbon monoxide stabilization. The intense heat from the Sun can be focused on a contained supply of carbon dioxide (CO2) gas up to temperatures such as 1100 Celsius. The heat divides the carbon dioxide (CO2) gas into carbon monoxide (CO) and oxygen (O2). The oxygen is separated from the gas stream for ancillary use or sale, while the CO is used as the chemical foundation for the production of various clean fuels, such as ethanol, methanol or synthetic gas. The residual carbon dioxide is captured and recycled in the process, resulting in a carbon neutral clean-fuel generating cycle. The quencher may be a heat exchanger placed immediately downstream of the chemical reactor to cool the gas below 700 Celsius, where radicals involved in the back reaction are favored. Quenching is also aided after the gases exit the reaction chamber, as moving the gases away from the catalyst raises the activation energy back to its normal level, and thereby preventing the gases from rolling back to the left in the Synthesis gas reaction discussed above. The cooling process may use active conduction methods to remove heat for faster quenching and use passive convection heat transfer methods for slower and cheaper heat removal.

Referring to FIG. 3c, shows another embodiment of the solar assisted synthesis gas generation process.

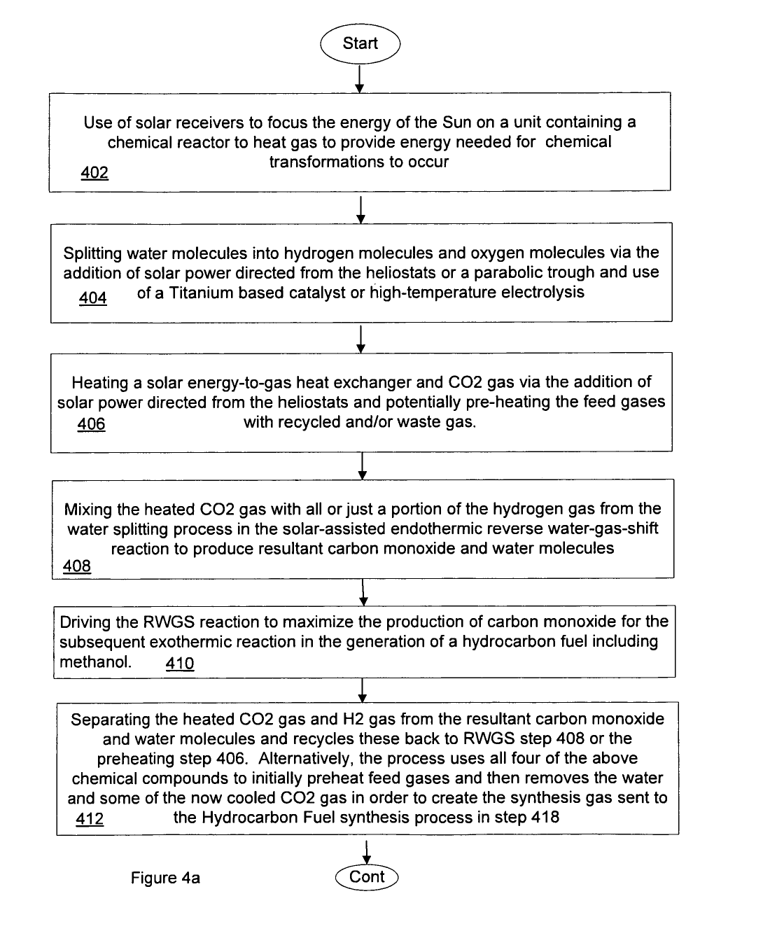

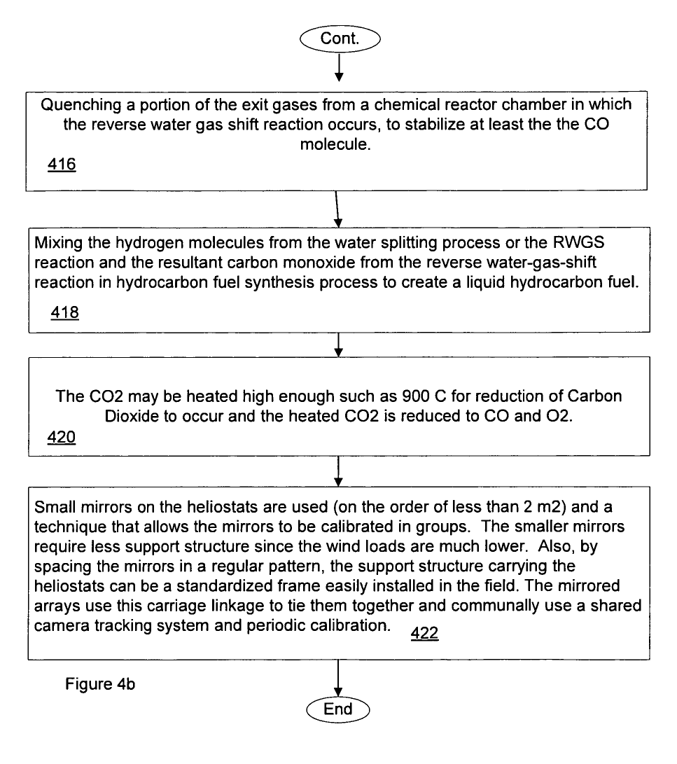

FIGS. 4a and 4b illustrate a flow diagram to generate methanol from solar heated carbon dioxide.

In block 402, the process uses solar receivers, such as heliostats, to focus the energy of the Sun on a unit containing a chemical reactor to heat gas to provide energy needed for chemical transformations to occur.

In block 404, the process splits water molecules into hydrogen molecules and oxygen molecules via the addition of the solar power directed from the solar receivers and uses a titanium based catalyst in the water splitting process that absorbs at least the UV rays directed from the solar receivers. The process may also split water with a high temperature electrolysis process.

In block 406, the process heats a solar-energy-to-gas-heat-exchanger and the carbon dioxide gas via the addition of solar power directed from the solar receivers and potentially pre-heating the feed gases with recycled and/or waste gas.

In block 408, the process mixes the heated carbon dioxide gas with all of or just a first portion of the hydrogen gas from the water splitting process in the solar-assisted endothermic reverse water gas shift reaction to produce resultant carbon monoxide and water molecules.

In block 410, the process drives the RWGS reaction to maximize the production of carbon monoxide for the subsequent exothermic reaction in the generation of a hydrocarbon fuel including methanol. As discussed above, one of the ways would be to remove water vapor from the chemical reactor chamber in which the reverse water gas shift reaction occurs and overload the input of carbon dioxide for maximum H2 consumption. Another method is to overload an amount of moles of heated hydrogen molecules relative to an amount of carbon dioxide present in the chemical reactor chamber than necessary to achieve equilibrium in the reverse water gas shift reaction to force maximum production of the resultant carbon monoxide.

In block 412, the process separates the heated carbon dioxide gas and H2 gas from the resultant carbon monoxide and water molecules and recycles these back to RWGS step 408 or the preheating step 406. Alternatively, the process uses all four of the above chemical compounds to initially preheat feed gases and then removes the water and some of the now cooled carbon dioxide gas in order to create the synthesis gas sent to the Hydrocarbon Fuel synthesis process in step 418.

Thus, the process recycles the separated out carbon dioxide after its been used in the recuperater back to the solar-energy-to-gas-heat-exchanger area. The process may also recycle none of the H2 if it is all being sent through the RWGS reaction and then the unconsumed H2 is sent onto the fuel process. The process may recycle a portion of the unconsumed H2 gas if that portion is being used to initially overload the H2 concentration and then recycled to preheat feed gas and reused in the RWGS reaction.

In block 416, the process quenches a portion of the exit gases from a chemical reactor chamber in which the reverse water gas shift reaction occurs, to stabilize at least the CO molecule.

In block 418, the process mixes the hydrogen molecules from the water splitting process or RWGS reaction and the resultant carbon monoxide from the reverse water gas shift reaction in hydrocarbon fuel synthesis process to create a liquid hydrocarbon fuel.

In block 420, the carbon dioxide may be heated high enough such as 900 Celsius to 2100 Celsius for solar reduction of Carbon Dioxide to occur and the heated carbon dioxide is reduced to CO and O2. The intense solar energy from a well-focused heliostat array super-heats and dissociates the carbon dioxide. Some of the carbon dioxide becomes carbon monoxide and oxygen. Then the reaction is “quenched” by fast cooling, preserving the products from back-reaction (recombination). Thus, the dissociation reaction can be cooled to prevent back-reaction. The resulting mix of carbon dioxide, carbon monoxide, and oxygen gas is separated into its three components. The carbon dioxide is recycled back into the process. The oxygen can be used for many valuable purposes. The carbon monoxide, an energy-rich molecule, carries the captured solar energy in its bonds. Waste heat from the process generates high quality steam to potentially turn an electricity-producing turbine.

In block 422, the small mirrors in heliostats array are used to heat the carbon dioxide gas. A technique that allows the mirrors to be calibrated in groups is used. The smaller mirrors require less support structure since the wind loads are much lower. Also, by spacing the mirrors in a regular pattern, the support structure carrying the heliostats can be a standardized frame easily installed in the field. The mirrored arrays use this carriage linkage to tie them together and communally use a shared camera tracking system and periodic calibration.

As discussed, the process allows for a high enough volume of hot carbon dioxide gas for commercial quantities of carbon monoxide for hydrocarbon based fuel generation, such as via methanol synthesis, and may even allow for a higher volume of hot gas for operation of the Brayton cycle turbine engine.

### Operation of the Brayton Cycle Turbine Engine

The Brayton cycle turbine engine 132 receives a portion of the carbon dioxide gas from the solar-energy-to-gas-heat-exchanger. The high quality heat from the carbon dioxide gas is transferred from the carbon dioxide gas to steam to run a turbine portion of the turbine engine that generates electricity. The heated carbon dioxide gas is heated to steady state temperature between 800 and 1000 degrees Celsius. The quantity of excess heat is used to generate power through the traditional Brayton cycle, using microturbine-generators.

Thus, the Brayton engine 132 is driven with gas heated from the solar energy and that same solar energy is a heat source for the transforming carbon dioxide to CO in the RWGS. The Brayton engine 132 is configured with a higher throughput, lower entropy production design, which is more advantageous for heating at up to 900 Celsius. The same solar energy is doing twice the work, resulting in much more efficient power production. The Brayton turbine engine 132 unit can produce electrical power.

In an embodiment, the Brayton Engine 132 is driven (in the form of a Capstone 30 engine) with the same focusing dish or a field of heliostats array or similar mechanism to concentrate the Sun's rays. For this work, the process uses a heat exchanger that can be capable of transferring 70 kW of solar energy into heat and high flow gas to drive the Brayton Engine. This is the low entropy heat exchanger. The heat exchanger should be able to heat, for example, 200 cubic feet per minute of gas (Cp=7.5 cal/mole deg) 500 degrees Celsius in a single pass. This could easily result in final temperatures of 900 Celsius. These temperatures are not only excellent for Brayton engines, but also for methane reforming.

In one embodiment, the software used to facilitate the processes discussed above can be embodied onto a machine-readable medium. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; Digital VideoDisc (DVD's), EPROMs, EEPROMs, FLASH memory, magnetic or optical cards, or any type of media suitable for storing electronic instructions. The software may be written in any number of programming languages such as C, C+, etc.

While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The reverse water gas shift reactor and the methanol synthesis reactor can be part of two separate units located in relatively close proximity of each other, such as both being on the same production facility site. The H2, Carbon monoxide (CO), and carbon dioxide recirculation loops may be combined. For example, the H2, Carbon monoxide (CO) may be combined when sent to the methanol synthesis reactor. The H2 and carbon dioxide may be combined when recirculated back to the RWGS process. The system may use two or more discrete solar-energy-to-gas-heat-exchangers. The array of heliostats may be formed in two or more sets of heliostats. The solar energy receiver may be heliostats or other devices such as solar collector mirrors, parabolic troughs, or any number of other apparatus to focus the rays of the sun. The invention is to be understood as not limited by the specific embodiments described herein, but only by scope of the appended claims.

What is claimed is:

1. A method, comprising:
use of one or more sets of solar receivers to focus energy from solar power on a unit containing a chemical reactor to heat gas to provide energy needed for chemical transformations to occur;
splitting water molecules into hydrogen molecules and oxygen molecules via the addition of the solar power directed from the one or more sets of solar receivers;
heating a solar-energy-to-gas-heat-exchanger and carbon dioxide gas via the addition of the solar power directed from the one or more sets of solar receivers;
mixing the heated carbon dioxide gas with the hydrogen molecules from the water splitting process in a solar-assisted endothermic reverse water gas shift reaction in a ratio of one mole of carbon dioxide gas per three moles of hydrogen to produce resultant carbon monoxide, water molecules, unconsumed hydrogen and unconsumed carbon dioxide;
cooling unconsumed portions of the carbon dioxide gas and the hydrogen molecules from the reverse water gas shift reaction and the resultant carbon monoxide and water molecules in order to preheat at least the hydrogen molecules from the water splitting process; and
using the cooled hydrogen molecules and the carbon monoxide from the reverse water gas shift reaction in a hydrocarbon fuel synthesis process to create a liquid hydrocarbon fuel.

2. The method of claim 1, wherein the solar receivers include an array of heliostats, the liquid hydrocarbon fuel produced is methanol, and the water splitting occurs using a titanium based catalyst.

3. The method of claim 1, wherein substantially all of the moles of hydrogen molecules 1) generated from the water splitting and 2) run through the reverse water gas shift reaction but not consumed by the reverse water gas shift reaction are sent with the resultant carbon monoxide from the reverse water gas shift reaction and between 0.1% to 3% by volume of carbon dioxide to the hydrocarbon fuel synthesis process to create the liquid hydrocarbon fuel.

4. The method of claim 1, wherein the reverse water gas shift reaction is driven to maximize production of carbon monoxide for a subsequent exothermic reaction in the generation of the hydrocarbon fuel, including methanol, by overloading an amount of hydrogen molecules relative to an amount of carbon dioxide present during the reverse water gas shift reaction and the hydrogen molecules supplied from the water splitter are also heated with the carbon dioxide by the one or more sets of solar receivers.

5. The method of claim 4, wherein the solar receivers include an array of heliostats to focus the solar power onto the solar-energy-to-gas-heat-exchanger to heat the carbon dioxide gas and hydrogen molecules up to temperatures of 1500 Celsius as an upper temperature limit and the hydrogen molecules from the water splitting are contained in a first outer pipe and feed carbon dioxide gas is contained in a second outer pipe during the heating by the unconsumed portions of the carbon dioxide gas and the hydrogen molecules from the reverse water gas shift reaction and the resultant carbon monoxide and water molecules from the reverse water gas shift reaction contained in an inner pipe.

6. The method of claim 1, wherein the solar receivers include an array of heliostats to focus the solar power onto the solar-energy-to-gas-heat-exchanger to heat the carbon dioxide gas to a steady state temperature between 800-900 degrees Celsius as the carbon dioxide gas exits the heat exchanger area and a quenching unit is placed immediately downstream of a chemical reactor to cool at least the produced carbon monoxide gas below degrees 700 Celsius, where radicals involved in a back reaction are favored, and the heat exchanger moves the resultant carbon monoxide away from a catalyst located in the chemical reactor, which then also raises an activation energy of the carbon monoxide to revert back to carbon dioxide.

7. An apparatus, comprising:
a window, where a first array of heliostats focus solar energy thru the window to a solar-energy-to-gas-heat-exchanger to heat gas which provides energy needed for chemical transformations to occur, wherein the solar-energy-to-gas-heat-exchanger receives the solar energy directed from the first array of heliostats to heat carbon dioxide gas via convection heating of the carbon dioxide gas from the heated solar-energy-to-gas-heat-exchanger;
a gas supply input to receive gases from a water splitter that splits water molecules into hydrogen molecules and oxygen molecules via the addition of the solar energy directed from at least one of 1) the first array of heliostats, 2) a second array of heliostats, and 3) a parabolic trough;
a chemical reactor chamber to mix the heated carbon dioxide gas with the hydrogen molecules from the water splitter in the form of gas in a reverse water gas shift reaction to produce resultant carbon monoxide and water molecules;
a recuperator to pre-heat both the carbon dioxide gas and hydrogen molecules prior to the carbon dioxide gas and the hydrogen molecules entering the chemical reactor chamber using energy of at least unconsumed carbon dioxide gas exiting the chemical reactor chamber; and
a gas supply output to supply at least the resultant carbon monoxide molecules and unconsumed hydrogen molecules from the reverse water gas shift reaction to a hydrocarbon liquid fuel synthesis reactor to create a liquid hydrocarbon fuel.

8. The apparatus of claim 7, wherein the liquid hydrocarbon fuel produced is methanol, the water splitter splits water with a titanium based catalyst that absorbs at least the UV rays directed from the second array of heliostats, and the recuperator also uses the unconsumed hydrogen molecules from the reverse water gas shift reaction to preheat the hydrogen molecules and carbon dioxide gas through heat exchanging surfaces prior to the carbon dioxide gas and the hydrogen molecules entering the chemical reactor chamber.

9. The apparatus of claim 7, wherein substantially all of the moles of hydrogen molecules 1) generated from the water splitter and 2) passed through the chemical reactor chamber which are not consumed by the reverse water gas shift reaction are sent with the resultant carbon monoxide from the reverse water gas shift reaction and between 0.1% to 3% by volume of carbon dioxide to the hydrocarbon fuel synthesis process to create the liquid hydrocarbon fuel.

10. The apparatus of claim 7, further comprising:
a condenser coupled to the recuperator and the water splitter, wherein removal of water vapor from the recuperator occurs in the condenser, which then routes that removed water to the water splitter.

11. The apparatus of claim 7, wherein the first array of heliostats each have a mirror less than two meters squared, each heliostat is attached to a communal standardized frame, and uses a technique that allows the mirrors to be calibrated in groups via use of a shared camera tracking system.

12. The apparatus of claim 7, wherein the solar-energy-to-gas-heat-exchanger heats the carbon dioxide gas to a steady state temperature between 200-1000 Celsius as the gas exits the heat exchanger area and gas flow is in the direction along the solar-energy-to-gas-heat-exchanger at its relative lowest temperature area and flows along the heat exchanger to the heat exchanger's highest temperature area.

13. The apparatus of claim 12, wherein the reverse water gas shift reaction is driven to maximize production of carbon monoxide for the subsequent exothermic reaction in the generation of methanol as a hydrocarbon fuel, by supplying at least fifty percent more moles of heated hydrogen molecules relative to an amount of carbon dioxide present in the chemical reactor chamber than necessary to achieve equilibrium in the reverse water gas shift reaction to force maximum production of the resultant carbon monoxide.

14. The apparatus of claim 12, wherein in the reverse water gas shift reaction the heated carbon dioxide is added to the hydrogen from the water splitter in a ratio of one mole of carbon dioxide per three moles of hydrogen in the presence of a catalyst in the chemical reactor chamber to yield at least one mole of carbon monoxide and some unconsumed hydrogen, as well as the chemical reactor chamber has surface areas coated or filled with a nickel-based catalyst material.

15. The apparatus of claim 7, wherein the recuperator plumbs pipes to the gas supply input ports and passes the exhaust gases from the chemical reactor chamber in an inner pipe in order to pre-heat the carbon dioxide and hydrogen gases passed through one or more larger outer pipes carrying the carbon dioxide and hydrogen gases.

16. The apparatus of claim 7, wherein the solar-energy-to-gas-heat-exchanger has a radially variable flow channel cross section through a crinkled foil, and the solar-energy-to-gas-heat-exchanger uses deeper crinkles near the center of the coil and small channels at the outside of the coil.

17. The apparatus of claim 7, further comprising:
a Brayton cycle turbine engine to receive a portion of the heated carbon dioxide gas from the solar-energy-to-gas-heat-exchanger, wherein high quality heat from the carbon dioxide gas is transferred from the carbon dioxide gas to steam in order to run a turbine portion of the turbine engine that generates electricity, wherein the heated carbon dioxide gas is heated to a steady state temperature between 800 and 1000 degrees Celsius.

18. A system, comprising:
a solar collector to focus solar energy to a water splitter to split water molecules into hydrogen molecules and oxygen molecules;
a first array of heliostats to focus solar energy to a solar-energy-to-gas-heat-exchanger to heat carbon dioxide gas and the hydrogen molecules via convection heating of the carbon dioxide gas and the hydrogen molecules from the heated solar-energy-to-gas-heat-exchanger;
a Nickel alloy based chemical reactor chamber to mix the heated carbon dioxide gas with the hydrogen molecules from the water splitter in a reverse water gas shift reaction in order to produce at least resultant carbon monoxide and water molecules as well as unconsumed hydrogen, wherein the reverse water gas shift reaction is driven to maximize production of the carbon monoxide by supplying at least more moles of heated hydrogen molecules relative to an amount of carbon dioxide gas present in the chemical reactor chamber than necessary to achieve equilibrium in the reverse water gas shift reaction to force maximum production of the resultant carbon monoxide; and
a methanol synthesis reactor to mix the hydrogen molecules and the resultant carbon monoxide molecules from the reverse water gas shift reaction in a methanol synthesis process to create methanol.

19. The system of claim 18, wherein the water splitter splits water with a titanium based catalyst that releases electrons to split the water to make the hydrogen molecules and oxygen molecules, and the titanium based catalyst is in a shape to strain the catalyst to pull apart its atoms and allow the titanium based catalyst to absorb both visible light and ultraviolet light.

20. The system of claim 18, further comprising:
a filter to separate the heated carbon dioxide gas and hydrogen molecules from the resultant carbon monoxide;
one or more recycle pipes to recycle the separated out carbon dioxide gas and hydrogen molecules back to the solar-energy-to-gas-heat-exchanger area; and
a quenching unit to cool at least a portion of the exit gases from the nickel alloy based chemical reactor chamber in which the reverse water gas shift reaction occurs, in order to stabilize at least the resultant carbon monoxide molecule in the exit gases, wherein the solar collector is a second set of heliostats, and the heliostats in the first array each have a mirror less than two meter squared, each heliostat is attached to a communal standardized frame, and use a technique that allows the mirrors to be calibrated in groups via use of a shared camera tracking system, where an algorithm used in calibration of each these heliostats takes data points with a set of cameras connected to digital imaging software in a computer, which can then be used to back-calculate heliostat position in a field relative to a target, and potential targets include a unit containing the solar-energy-to-gas-heat-exchanger and the water splitter, the methanol synthesis reactor receives additional hydrogen molecules from the water splitter, and reformation to synthesis gas occurs at approximately 800-1000 degrees Celsius, approximately 1000 sun concentration units, and approximately 15 psi pressure.
